(19) United States
(12) Patent Application Publication
(10) Pub. No.: US 2008/0040734 A1
(43) Pub. Date: Feb. 14, 2008

(54) INFORMATION PROCESSING APPARATUS AND CONTROL METHOD

(75) Inventor: Ryo Hatano, Kodaira-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 11/836,115

(22) Filed: Aug. 8, 2007

(30) Foreign Application Priority Data
Aug. 8, 2006 (JP) 2006-216126

(51) Int. Cl. G11B 17/03

(52) U.S. Cl. 720/600

(57) ABSTRACT

According to one embodiment, an information processing apparatus includes window display unit which displays on a display device a window including buttons with which a user selects a recording to be accessed by the optical disc apparatus, when a third optical disc including a recording layer recorded in a first physical format and a recording layer recorded in a second physical format is loaded to a optical disc apparatus, access layer instructing unit which instructs to the optical disc apparatus a recording layer to be accessed by the optical disc apparatus in reply to an operation of a button by the user, and result display unit which displays information on the recording layer to be accessed by the optical disc apparatus by the operation of the user in reply to an operation of a button by the user.

### CROSS-REFERENCE TO RELATED APPLICATIONS

This application is based upon and claims the benefit of priority from Japanese Patent Application No. 2006-216126, filed Aug. 8, 2006, the entire contents of which are incorporated herein by reference.

### BACKGROUND

1. Field

One embodiment of the invention relates to a information processing apparatus for reproducing contents recorded on an optical disc including two recording layers of different physical formats from each other and its control method.

2. Description of the Related Art

Recently, digital versatile discs (DVD) and their playing apparatuses have become very popular and even High Definition DVDs (or High Density DVDs), which are designed for a higher-density recording and higher image-quality recording, have been introduced to the market. An example of such playing apparatus is disclosed in Jpn. Pat. Appln. KOKAI Publication No. 9-44984.

As one type of discs that can reproduce HD DVD data, a disc which includes, in one disc two, recording layers of different physical formats, namely, a DVD recording layer and an HD DVD recording layer has been introduced to the market (twin format disc). Further, a playing apparatus that can select the HD DVD layer or DVD layer of a twin format disc and reproduce data recorded on the selected layer has been introduced to the market.

The above-described apparatus that can reproduce a twin format disc such as above can reproduce either one of the recording layers, the DVD layer and HD DVD layer, which is selected by the user.

However, this conventional apparatus entails such a drawback that once one layer is selected, there is no way of knowing which layer is presently reproduced.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing a person computer used as a data processing apparatus according to an embodiment of the present invention;

FIG. 2 is an exemplary block diagram showing the configuration of the personal computer shown in FIG. 1;

FIG. 3 is an exemplary diagram showing the relationship between the basic structure of a one-sided single-layer DVD disc and an optical head;

FIG. 4 is an exemplary diagram showing the recording area configuration of the one-sided single-layer DVD disc;

FIG. 5 is an exemplary diagram showing the relationship between the basic structure of another one-sided single-layer DVD disc and another optical head;

FIG. 6 is an exemplary diagram showing the recording area configuration of this one-sided single-layer DVD disc;

FIG. 7 is an exemplary diagram showing the relationship between an example of the basic structure of a twin format disc and an optical head;

FIG. 8 is an exemplary diagram showing an example of the recording area configuration of the twin format disc;

FIG. 9 is an exemplary block diagram showing the configuration of an optical disc according to an embodiment;

FIG. 10 is a diagram showing a window displayed on an LCD by a player software for reproducing the contents recorded on a disc loaded on an optical disc apparatus;

FIG. 11 is an exemplary diagram showing a control window displayed on the LCD;

FIG. 12 is an exemplary block diagram showing the configuration of a player software according to an embodiment;

FIG. 13 is an exemplary diagram illustrating the procedure of the playback process carried out by the player software;

FIG. 14 is an exemplary diagram illustrating the procedure of the process of identifying the type of disc, carried out by the optical disc apparatus;

FIG. 15 is an exemplary diagram illustrating a status of the HD DVD-layer selection button and DVD-layer selection button;

FIG. 16 is an exemplary diagram illustrating another status of the HD DVD-layer selection button and DVD-layer selection button;

FIG. 17 is an exemplary diagram illustrating another status of the HD DVD-layer selection button and DVD-layer selection button;

FIG. 18 is an exemplary diagram illustrating another status of the HD DVD-layer selection button and DVD-layer selection button; and

FIG. 19 is an exemplary diagram illustrating the procedure of the playback process carried out by the optical disc apparatus.

### DETAILED DESCRIPTION

Various embodiments according to the invention will be described hereinafter with reference to the accompanying drawings. In general, according to one embodiment of the invention, an information processing apparatus comprises an optical disc apparatus to which one type of optical disc selected from the group consisting of a first optical disc including a recording layer recorded in a first physical format accessed by first laser light, a second optical disc including a recording layer recorded in a second physical format accessed by second laser light, and a third optical disc including a first recording layer recorded in the first physical format and a second recording layer recorded in the second physical format, is loaded, and which reads data recorded on a loaded disc, an identification unit which identifies a type of an optical disc loaded in the optical disc apparatus, a window display unit which displays on a display device a window including buttons with which a user selects a recording to be accessed by the optical disc apparatus when it is judged that the third optical disc is loaded, an access layer instructing unit which instructs to the optical disc apparatus a recording layer to be accessed by the optical disc apparatus in reply to an operation of a button by the user, and an operation result display unit which displays information on the recording layer to be accessed by the optical disc apparatus by the operation of the user in reply to an operation of a button by the user.

Embodiments of the present invention will now be described with reference to accompanying drawings.

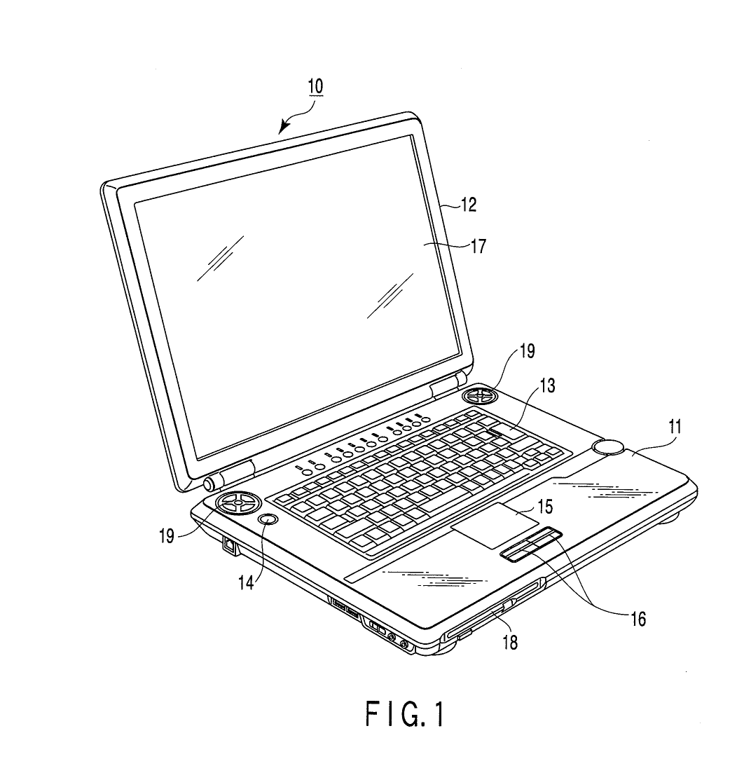

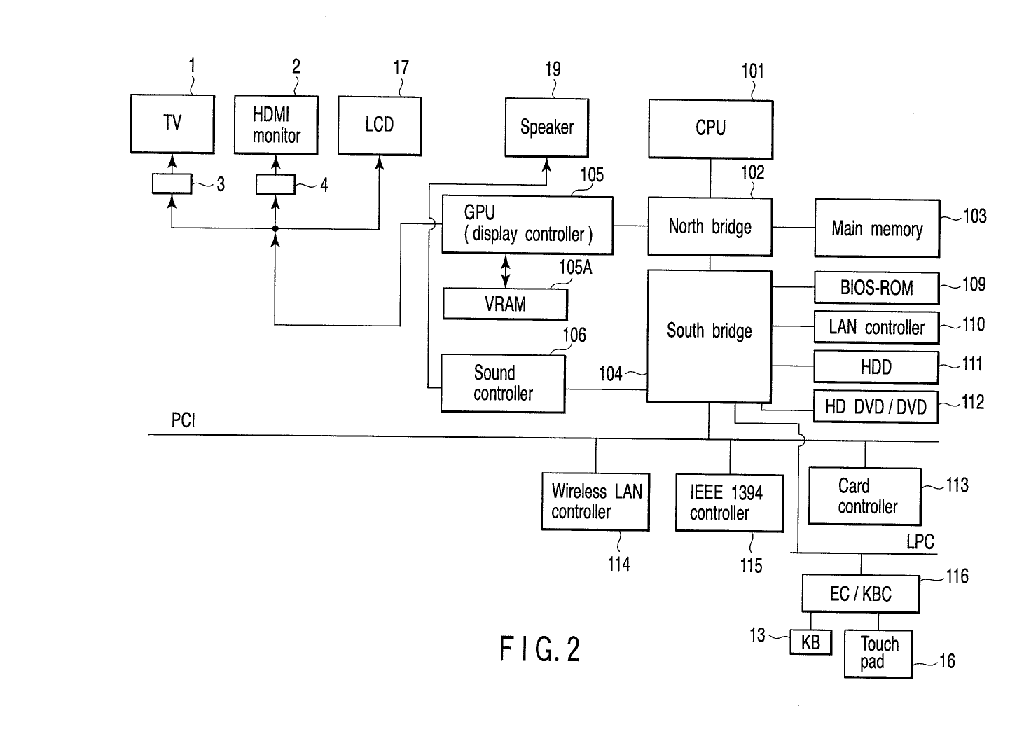

First, with reference to FIGS. 1 and 2, the structure of the data processing apparatus according to an embodiment of the present invention. This data processing apparatus is realized as, for example, a notebook personal computer 10.

FIG. 1 is a perspective view of the notebook personal computer 10 while the display unit is open.

The computer 10 includes a computer main body 11 and a display unit 12. The display unit 12 contains a display device of a thin film transistor liquid crystal display (TFT-LCD) 17 built therein, and the display screen of the LCD 17 is located substantially at a central portion of the display unit 12.

The display unit 12 is set on the computer main body 11 such as to be rotatable between the open position and close position. The computer main body 11 includes a thin box-shaped cabinet, on an upper surface of which, a keyboard 13, a power button 14 for turn ON/OFF the power of the computer 10, a touch pad 15, a touch pad control button 16, a speaker 19, etc. are arranged.

Next, with reference to FIG. 2, the system configuration of the computer 10 will now be described.

As shown in FIG. 2, the computer 10 includes a CPU 101, a north bridge 102, a main memory 103, a south bridge 104, a graphic processing unit (GPU) 105, a video memory (VRAM) 105A, a sound controller 106, a BIOS-ROM 109, a LAN controller 110, a hard disc drive (HDD) 111, a high definition digital versatile disc (HD DVD/DVD compatible drive (ODD, optical disc apparatus) 112, a card controller 113, a wireless LAN controller 114, an IEEE 1394 controller 115, an embedded controller/keyboard controller IC (EC/KBC) 116, and the like.

The CPU 101 is a processor that controls the operation of the computer 10, and it executes the operating system and each of various types of application programs loaded from the hard disc drive (HDD) 111 to the main memory 103. The CPU 101 executes BIOS (basic input output system) stored in the BIOS-ROM 109. The BIOS is a program for controlling the hardware.

The north bridge 102 is a bridge device that connects a local bus of the CPU 101 and the south bridge 104. The north bridge 102 includes a memory controller built therein to access-controls the main memory 103. Further, the north bridge 102 has a function of executing communications with the GPU 105 via a serial bus of PCI EXPRESS.

The GPU 105 is a display controller that controls the LCD 17 used as a display monitor of the computer 10. Display signals generated by the GPU 105 are sent to the LCD 17. The display signals can as well be sent out to an external TV 1 and an external HDMI monitor via interfaces 3 and 4, respectively, provided in the computer main body 11.

The south bridge 104 controls each of devices on an LPC (low pin count) bus and each of devices on a PCI (peripheral component interconnect) bus. The south bridge 104 includes an IDE (integrated drive electronics) controller built therein to control the HDD 111 and ODD 112. Further, the south bridge 104 has a function of executing communications with the sound controller 106.

The sound controller 106 is a sound generating device and it outputs audio data to be reproduced to the speaker 19.

The card controller 113 controls cards such as a PC card and an SD (secure digital) card. The wireless LAN controller 114 is a wireless communication device that executes wireless communications of, for example, IEEE 802.11. The IEEE 1394 controller 115 executes communications with an external device via a serial bus of IEEE 1394. The embedded controller/keyboard controller IC (EC/KBC) 116 is a 1-chip micro-computer in which an embedded controller for controlling the power and a keyboard controller for controlling the keyboard (KB) 13 and touch pad 15 are integrated. The embedded controller/keyboard controller IC (EC/KBC) 116 has a function of turning ON/OFF the power of the computer 10 in response to the operation of the power button 14 by the user. Further, the embedded controller/keyboard controller IC (EC/KBC) 116 has a function of executing communication with a remote control unit interface 20.

It should be noted here that the ODD 112 is compatible with the following 3 types of DVD media, namely, digital versatile disc (DVD), high definition digital versatile disc (HD DVD) and twin format disc. The twin format disc is a medium provided with two recording layers with different physical formats in one disc, that is, a recording layer for a physical format for DVD and another recording layer for a physical format for HD DVD.

—DVD—

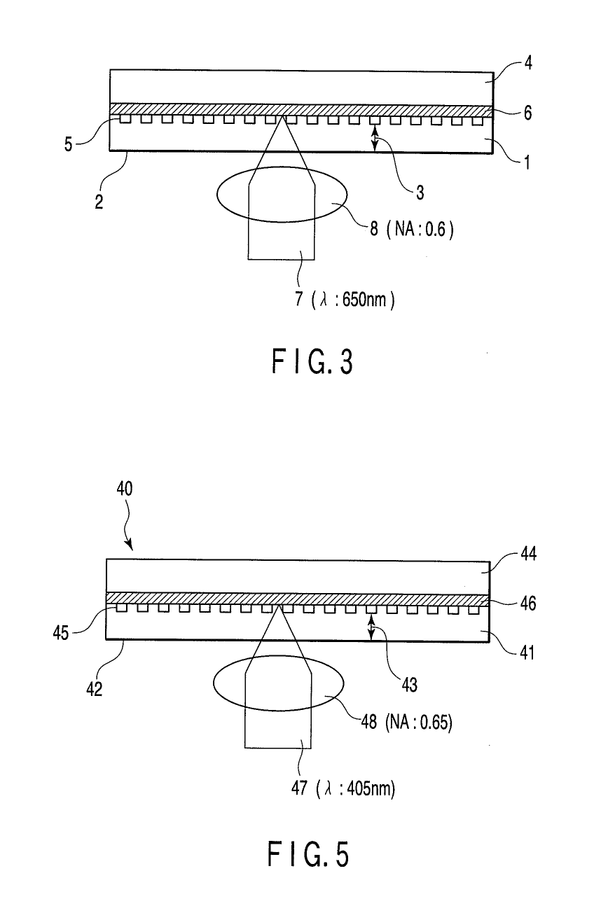

FIG. 3 shows the relationship between the basic structure of a one-sided single-layer DVD disc and an optical head. As is well-known, the DVD disc has such a structure that two disc substrates having a thickness of 0.6 mm are adhered together. One of the substrates is a signal substrate 1 and the other is a dummy substrate 4, and they are adhered together via a adhesive layer 6 such as to interpose a recording layer 5 therebetween. Usually, these substrates are made of a plastic material called polycarbonate by using an injection molding machine.

It should be noted that video data and other data are recorded in the form of emboss pits on spiral tracks. A red laser beam 7 (wavelength: 650 nm) is used for reading the data on the recording layer, and is concentrated by an objective lens 8 (NA: 9.6) and focused on the recording layer 5 via a light transmitting layer 3 of the signal substrate 1.

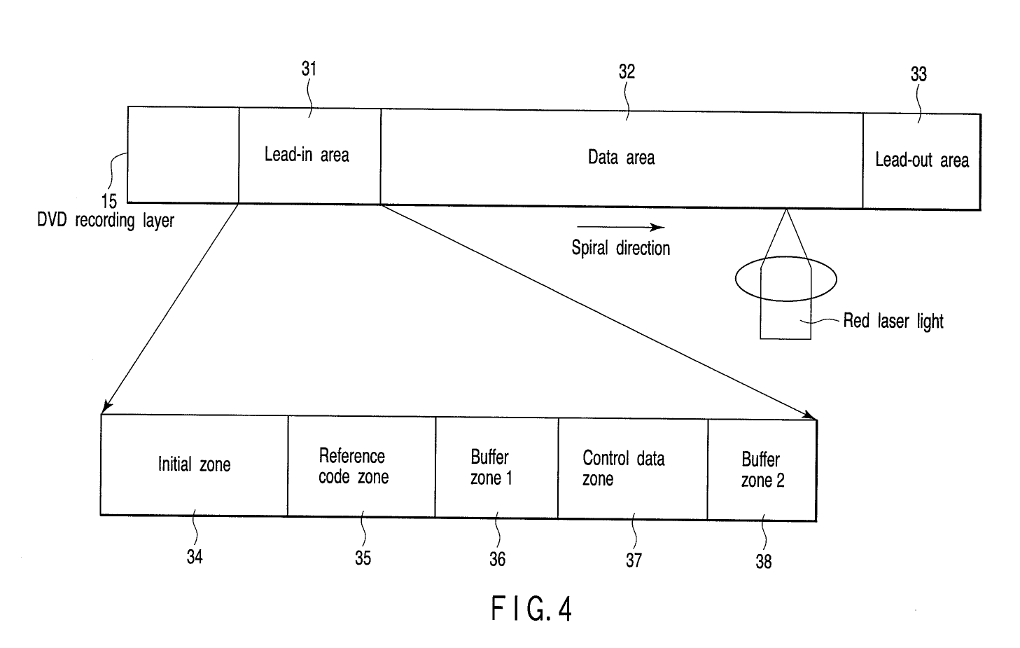

FIG. 4 is a diagram showing the recording area configuration of the one-sided single-layer DVD disc. The DVD recording layer 15 includes, from an inner circumferential side, a read-in area 31, a data area 32 and a read-out area 33. The read-in area 31 includes a control data zone 37 formed therein.

Further, an initial zone 34, a reference code zone 35, a buffer zone 36 and another buffer zone 38 are formed therein.

—HD DVD—

The HD DVD of a high density of three times or more as high as that of the DVD, which can be achieved using a blue-violet semiconductor laser (to be referred to as blue-violet laser hereinafter), has been introduced to the market. The HD DVD has the same disc structure as that of the conventional DVD. The one-sided single layer disc has a capacity of 15 GB, and the both sided twin layer disc has a capacity of 30 GB. The increase in capacity has been achieved by new techniques such as the shortening the wavelength of the laser beam, the increase in NA, a demodulation mode and a new signal processing mode (PRML: partial response and most likelihood).

FIG. 5 shows the relationship between the basic structure of a one-sided single-layer DVD disc 40 and an optical head. This disc is basically the same as DVD in structure, but for the higher density and larger capacity, a blue-violet layer beam 47 (having a wavelength of 405 nm) and an objective lens 48 having an NA value of 0.65 are used to read out signals.

Therefore, the spherical aberration, coma caused by tilting, etc. are more severe as compared to the case of DVD. Therefore, the minimum thickness of the light transmitting layer 43 is measured to be 587 μm from the light incident surface 42, and the maximum thickness is 613 μm.

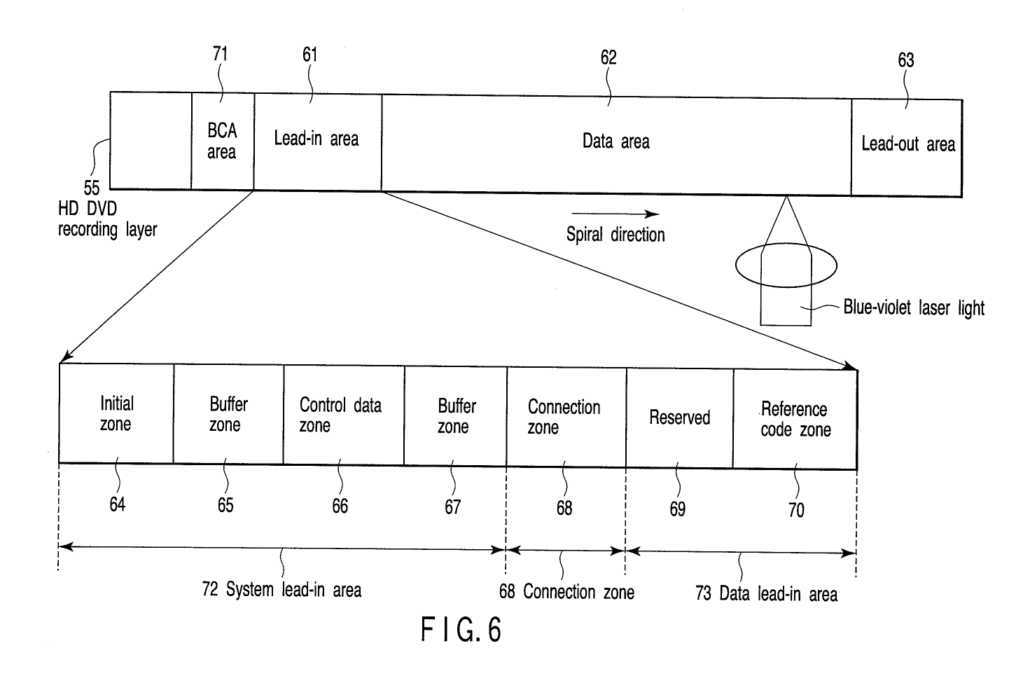

FIG. 6 is a diagram showing the recording area configuration of a one-sided single-layer DVD disc. An HD DVD recording layer 55 (, which corresponds to the recording layer 45 in FIG. 4) includes a lead-in area 61, a data area 62 and a lead-out area 63 as in the case of DVD, and further a BCA area 71. The BCA (burst cutting area) 71 is formed as an option in the case of DVD, whereas in the case of HD DVD, the BCA is essential. The lead-in area 61 includes a system lead-in area 72, a connection zone 68 and a data lead in area 73. The control data zone 66 is formed in a system lead in area 72. Besides, an initial zone 64 and buffer zones 65 and 67 are formed in the system lead in area 72. On the other hand, a reserved area 69 and a reference code zone 70 are formed in the data lead in area 73.

—Basic Structure of Twin Format Disc—

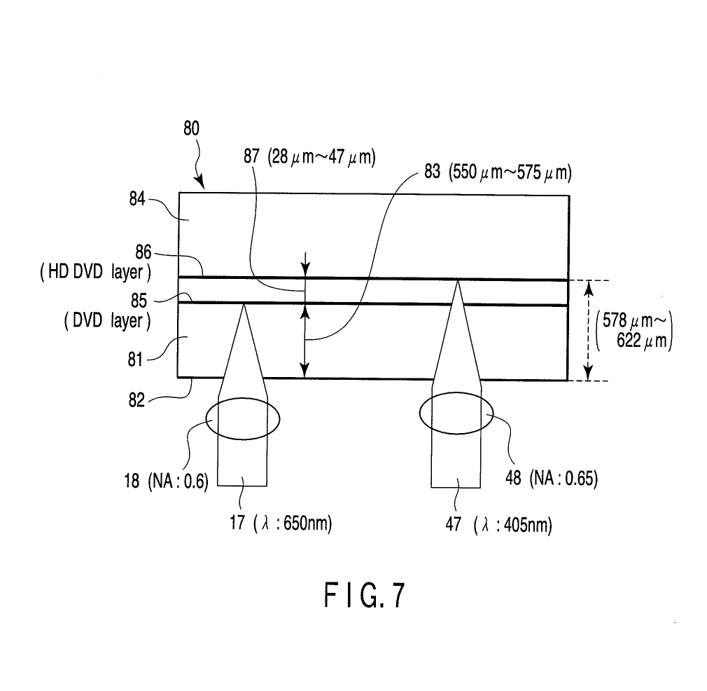

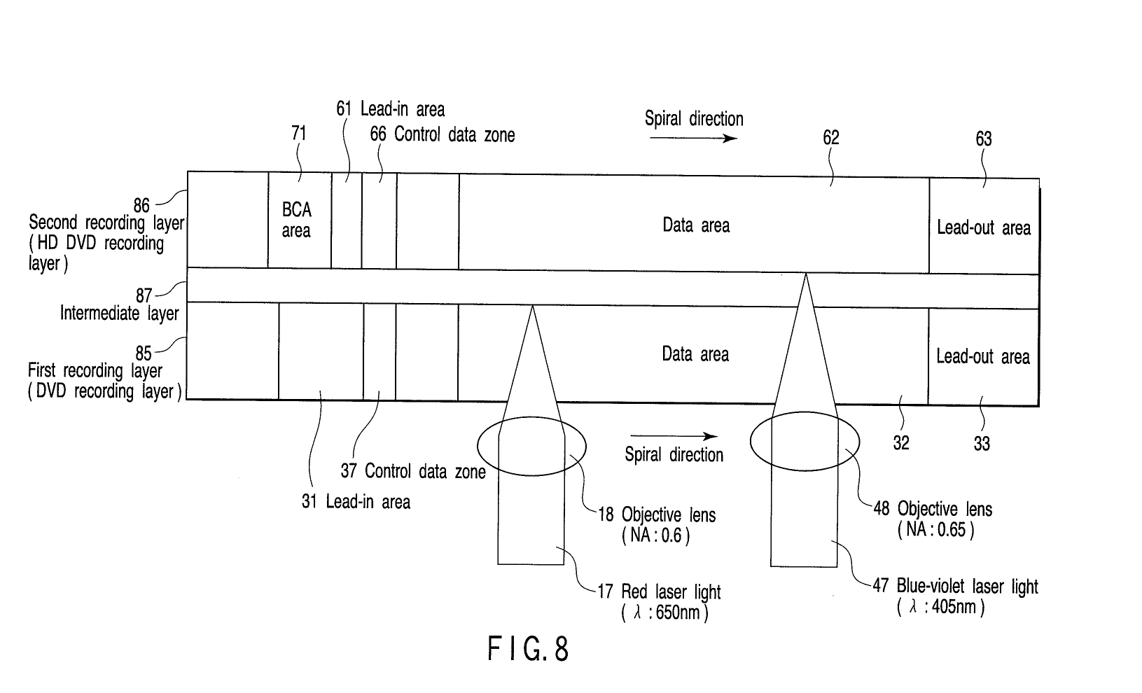

FIGS. 7 and 8 each show the relationship between an optical disc 80 and the optical head. FIG. 7 illustrates how the disc substrates shown in FIGS. 3 and 5 are adhered together.

As can be seen in FIG. 7, the optical disc 80 includes a first substrate 81 and a second substrate 84. In the disc, a first recording layer (, which corresponds to the DVD layer) 85 is formed of a semi-transparent layer in a location closer to a laser light incident surface 82, and a second recording layer (, which corresponds to the HD DVD layer) 86 is formed of a reflecting layer in a location remote from the laser light incident surface 82.

—Flag Data (DVD layer)—

In the case of twin format disc, the DVD layer 85 needs to be handled such as an ordinary one-sided single layer DVD-ROM disc.

The data indicating a currently-selected recording layer of the disc (that is, the layer number) is set to b24 (the 24-th bit) of 4-byte ID (identification data) of the data frame. When b24 is 0b, Layer0 of DL(Dual Layer) discs or on SL discs, and when b24 is 1b, Layer1 of DL discs.

The data indicating whether the number of recording layers of the disc is single or dual is indicated by the 6-th bit and the 5-th bit (b6-b5) of a byte position (BP2) of physical format information of the control data zone 37 formed in the lead in area 31, which defines the disc structure, shown in FIG. 3. When b6-b5 is 00b, the case of single or 1b indicates the dual type.

Therefore, the 24-th bit of the 4-byte ID in the data frame of the DVD layer of the twin format disc is 0b, and the 6-th bit and 5-th bit (b6-b5) of the byte position (BP2) of the physical format information of the control data zone 37 formed in the lead in area 31, are 00b.

—Identification Data (DVD layer)—

The data indicating that the HD DVD layer 86 is formed is recorded on the DVD layer 85 by utilizing b3 of the layer type in BP2 of the physical format information of the control data zone. This bit is reserved in recording DVD discs other than DVD-ROM disc, such as DVD-R/RW disc, DVD-RAM disc, etc., and therefore if this bit is used, no influence is exhibited.

Thus, 1b is recorded to b3 of BP2 of the physical format information of the control data zone, thereby setting that the first recording layer is for the DVD layer and the second recording layer is the HD DVD layer.

Other than the above, b7 of BP2 of the physical format information of the control data zone is reversed, and therefore it is alternatively possible that 1b is recorded to b7 to set that the first recording layer is for the DVD layer and the second recording layer is the HD DVD layer. That is, 1b is written in the 7-th bit to indicate that the first recording layer is for the DVD layer and the second recording layer is the HD DVD layer.

It should be noted that the physical format information of the control data zone has a total of 2048 bites, and a majority of them (BP) are reversed. Therefore, it is possible to use the disc in a usage range that does not conflict with some other recording discs.

Next, the flag data and identification data of the HD DVD layer 86 will now be described.

—Flag Data—

In the case of the twin format disc, the HD DVD layer 86 needs to be handled as an ordinary one-sided single layer HD DVD-ROM disc.

Therefore, the 24-th bit of the 4-byte ID in the data frame of the DVD layer of the twin format disc is 0b, and the 6-th bit and 5-th bit (b6-b5) of the byte position (BP2) of the physical format information of the control data zone 37 formed in the lead in area 31, are 00b.

—Identification Data (HD DVD Layer)—

The data indicating that the DVD layer 85 is formed is written on the HD DVD layer 86 by utilizing b3 of the layer type in BP2 of the physical format information of the control data zone. This bit is reserved in recording HD DVD-R discs other than HD DVD-ROM disc, such as recording HD DVD of HD DVD-Rewritable disc, etc., and therefore if this bit is used, no influence is exhibited.

Thus, 1b is recorded to b3 of BP2 of the physical format information of the control data zone, thereby setting that the first recording layer is for the DVD layer and the second recording layer is the HD DVD layer. In other words, 1b is written to b3 to indicate that the first recording layer is the DVD layer and the second recording layer is the HD DVD layer.

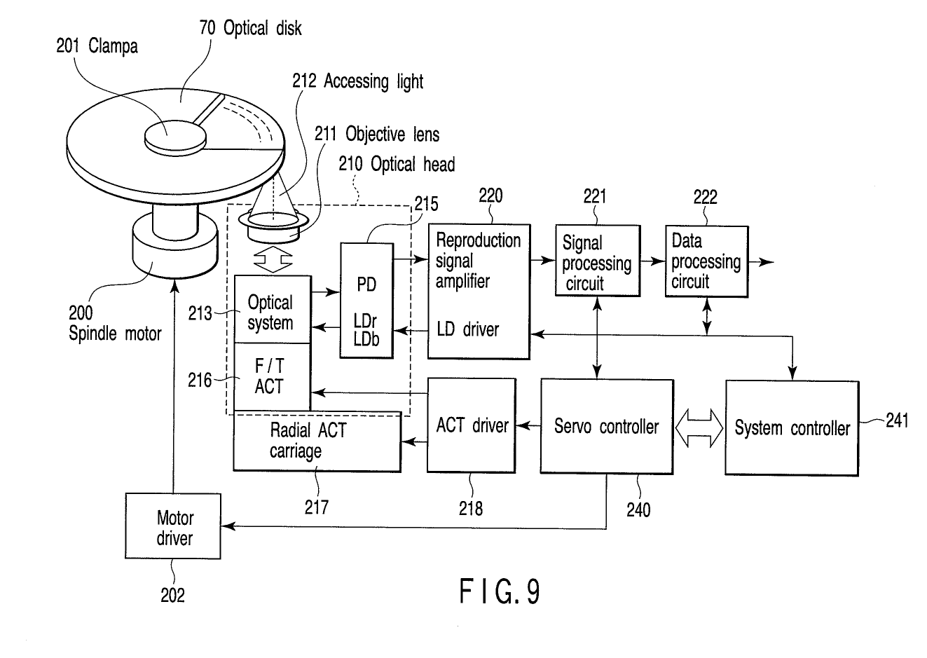

Next, the main structure of the HD DVD/DVD compatible drive will now be briefly described with reference to FIG. 9.

A spindle motor 200 serves to rotate a turntable as it is driven. A clamper 201 holds the optical disc 80 on the turntable. The spindle motor 200 is controlled by a motor driver 202. An optical head 210 includes an objective lens 211 and an optical system 213.

The objective lens 211 has a selectivity with regard to, for example, the wavelength of laser beam. Therefore, the numerical aperture varies adaptively from the case of red to that of blue-violet laser light. Alternatively, the objective lens may of a change-over type.

The optical system 213 is driven by a focus and tracking actuator 216. When the focus and tracking actuator 216 is controlled by an actuator driver 218, a laser beam output from a laser diode LDr for outputting red laser beam or another laser diode LDb for outputting blue-violet laser beam is focused on a track on the optical disc and the laser bam follows the track. A radial actuator 217 serves to move the optical head 210 to a radial direction of the disc and the actuator 217 is controlled by an actuator driver 218.

Reflection light from the disc is guided out from the optical system 213 and then converted into an electric signal by a photodetector of a photoelectric converting unit 215. The electric signal is gain-adjusted by a reproduction signal amplifier of a gain adjustment unit 220, and then inputted to a signal processing circuit 221. The signal processing circuit 221 carries out a demodulation process, buffering, error correction onto the signal, and the output signal is inputted to the data processing circuit 222, in which separation of a packet and separation of a control signal, etc. are carried out.

A servo controller 240 supplies a control signal to the actuator driver 218 using a focus error signal and a tracking error signal obtained by processing a reproduction signal from, for example, a 4-division photodiode. In reply to a signal from an input terminal (for example, a remote controller or an operating key entry unit) 242, the system controller 241 controls the operations such as play, stop, pause, etc. of the device. Further, the controller 241 controls a laser diode driver in the gain adjustment unit 220. The laser diode driver drives the laser diode mounted on the optical head 210, and as a result, laser light is outputted.

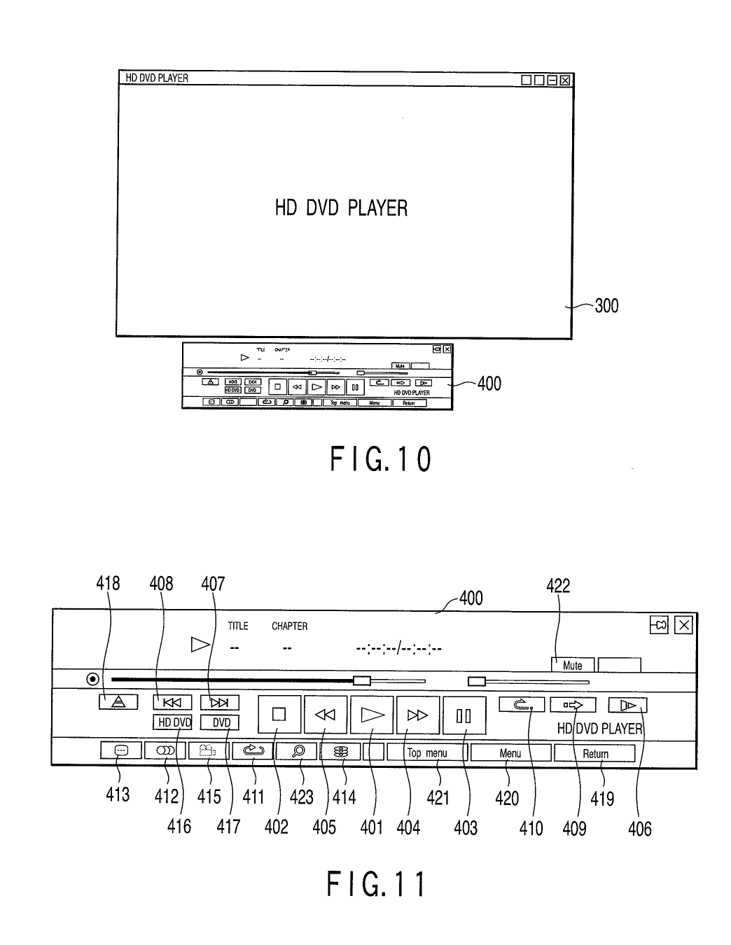

The computer 10 contains a player software for controlling the contents (image and sound) recorded on a DVD, HD DVD or twin format disc drive to be loaded on a multidisc drive. A window displayed on the screen of the LCD 17 by the player software is shown in FIG. 10. The player software displays on the LCD 17 a visual window for displaying images stored on a disc and a control window for controlling the playback function etc. of the player software.

FIG. 11 is an enlarged view of the control window. The control window includes a playback button 401 for carrying out playback of a disc, a stop button 402 for stopping play, a pause button 403 for temporarily suspending play, a fast-forward button 404 for fast-forward playback, a fast-reverse button 404 for fast-reversing play, a forward slow-motion play button 405 for forward slow-motion play, a next-chapter button 407 for skipping to the beginning of the next chapter, a previous-chapter button 408 for skipping back to the beginning of the previous chapter, a one-touch (instant?) replay button 409 for skipping back to a point about 15 seconds before the current playing point, a one-touch (instant?) skip button 410 for skipping to a point about 15 seconds after the current playing point, a repeat button 411 for repeating and canceling a chapter or title, a soundtrack selection button 412 for selecting the soundtrack language, a subtitle selection button 413 for selecting the language for subtitles, a drive/folder assignment button 414 for assigning a drive/folder, a view angle changing button 415 for switching the angle of view, a DVD layer selection button 416 for selecting the DVD layer as the recording/playback layer in the case where the disc loaded in the drive is a twin format disc, an HD DVD layer selection button 417 for selecting the HD DVD layer as the recording/playback layer in the case where the disc loaded on the drive is a twin format disc, an eject button 418 for ejecting the disc from the drive, a back button 419 for returning to a previous mode, a menu button 420 for displaying a menu, a top menu button 421 for displaying the top menu, a mute button 422 for temporarily muting the sound and a chapter-title search button 423 for searching for a particular chapter or title.

When a twin format disc is inserted to the ODD 112, the ODD 122 accesses the HD DVD layer. However, it is possible for the user to select the layer to be accessed by the drive by operating the DVD layer selection button 416 in the control window. Even while the DVD layer is selected, it is possible for the user to make the drive select the HD DVD layer by operating the HD DVD layer selection button 416 in the control window.

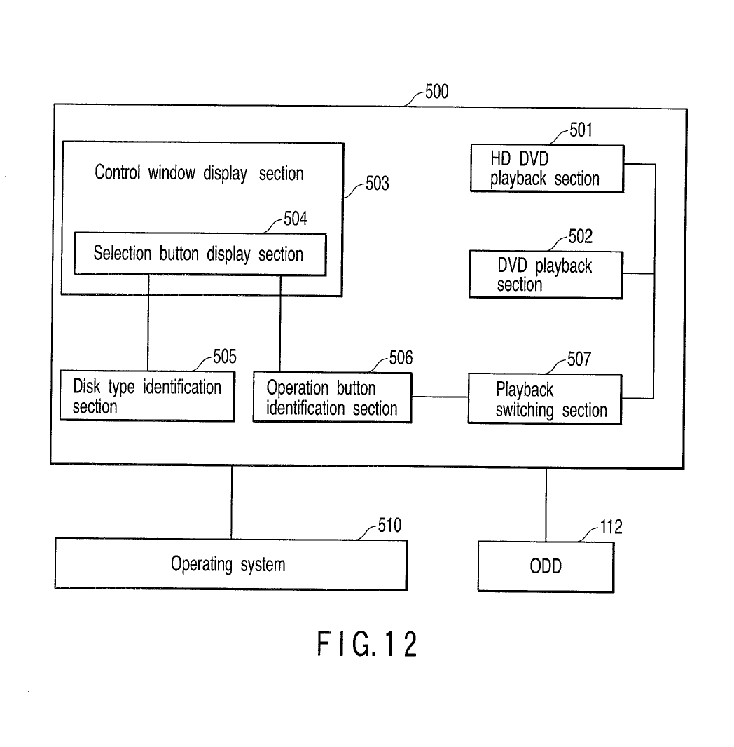

Next, the configuration of the player software will now be described with reference to FIG. 12. As illustrated in FIG. 12, the player software contains an HD DVD playback section 501 for reproducing the contents recorded on the HD DVD layer of an HD DVD or twin format disc, a DVD playback section 502 for reproducing the contents recorded on the DVD layer of a DVD or twin format disc, a control window display section (window display means) 503 for displaying a control window for controlling the playback function and the like of the player software, a selection button display section 504 for controlling the display of the HD DVD layer selection button 416 and the DVD layer selection button 417 in the control window 400, a disc type identification section (identification means) 505 for identifying the type of the disc inserted to the ODD 112, an operation button identification section (operation result display means) for identifying which one of the HD DVD layer selection button 416 and the DVD layer selection button 417 was operated when a button was operated, and a playback switching section (access layer instruction means) 507 for instructing the ODD 112 of which layer to be accessed in compliance with the operated button and instructing one of the HD DVD playback section 501 and the DVD playback section 502 to reproduce the contents.

Although the selection button display section 504 displays the operation result of the button 416 or 417 operated by the user, it can be also interpreted that the section displays the data of the recording layer accessed by the optical disc apparatus since the recording layer accessed by the ODD 112 changes in accordance with the operation result.

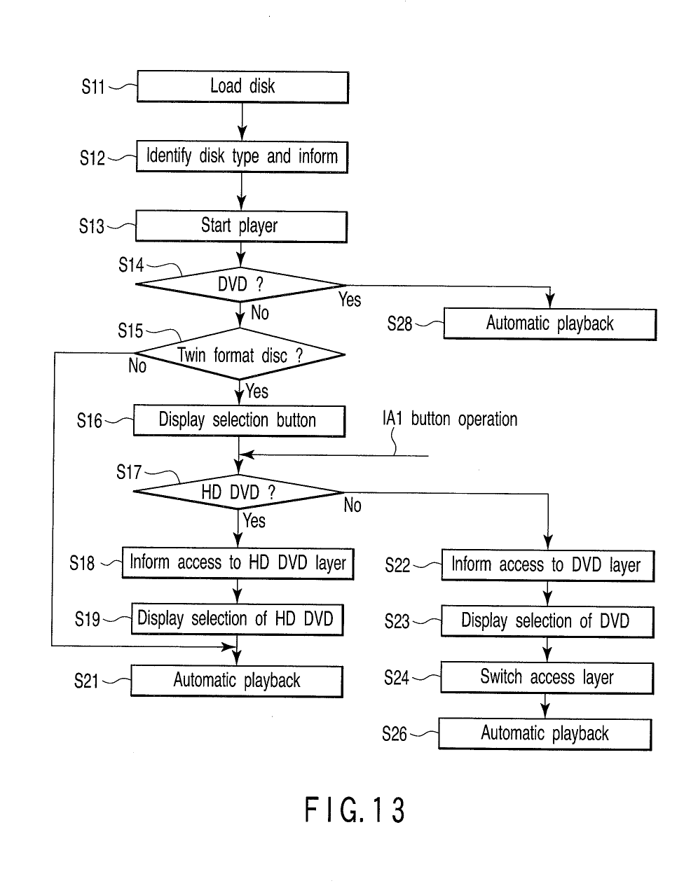

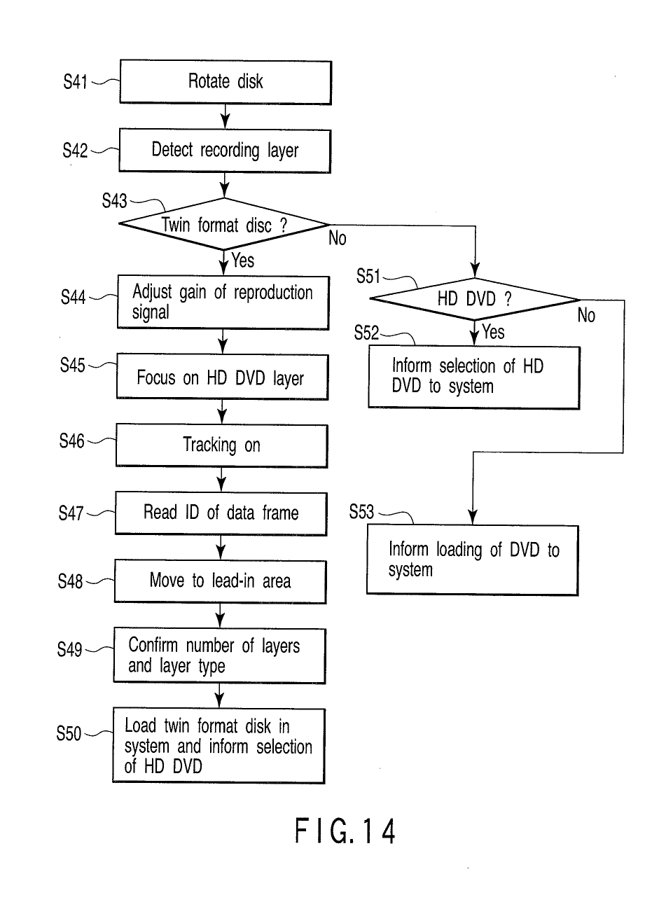

Next, the procedure of the process carried out when a disc is loaded in the ODD 112 will now be described with reference to FIGS. 13 and 14.

The user loads a disc into the drive (step S11). When the drive accepts the disc, the drive identifies the type of the disc and informs the identification result to the OS (step S12).

The process carried out in step S12 will be detailed in more detail with reference to the flowchart illustrated in FIG. 14.

When a twin format disc 80 is loaded in the drive, a spindle motor 100 is rotated up to a predetermined number of revolutions (step S41). Subsequently, the blue-violet laser is turned on to apply a beam onto the disc and then a periodical drive current is allowed to flow to the focus actuator 216 to move the optical head up and down in the axial direction. Thus, the detection of the recording layer is carried out (step S42).

The disc loaded in the drive is identified whether or not it is the twin format type based on the level of the focus signal (step S43). In the case where a twin format disc is loaded, it is possible to identify that the disc is of the twin format type since the focus signal indicates that there are two recording layers and they are different in level from each other. That is, there is a difference in amplification of, for example, 2 fold or more, between focus error signals of the first recording layer and the second recording layer of the twin format disc, and more specifically, the level of the focus error signal of the DVD layer is high, whereas that of the HD DVD layer is low.

In the case where the disc is identified to be of the twin format type (Yes in step S43), the gain of the reproduction signal is adjusted (step S44) to focus on the HD DVD layer (step S45). Then, when the tracking servo is turned on (step S46), an On-tracking state is acquired at an appropriate position.

Subsequently, ID of the data frame is read (step S47) and the area type, reflectivity and layer number of the disc are checked. Then, the radial actuator 217 is driven to move them to the lead in area (step S48).

After that, optical head 210 is moved to the control data zone, and the number of layers, layer type of BP2 of the physical format information are confirmed. The drive confirms based on the number of layers and layer type that the selected layer is the HD DVD layer of the twin form a disc (step S49).

Then, the drive informs the operating system 510 that a twin format disc is loaded and the HD DVD layer is selected (step S50).

In the case where the drive detects only one recording layer in the search of the recording layer in step S42, it is judged that the disc is not of a twin format type, but it is either one of DVD and HD DVD (No in step S43). Or in the case where two recording layers are detected in the search of the recording layer in step S42 and there is no substantial difference between the two in level, it is judged that the disc is not of a twin format type, but it is either one of DVD and HD DVD (No in step S43). Then, whether or not the disc is an HD DVD is judged (step S51).

When it is judged that the disc is an HD DVD (Yes in step S51), the drive informs the system that an HD DVD is loaded (step S52). When it is judged that the disc is not an HD DVD (No in step S51), the drive informs the system that a DVD is loaded (step S53).

The operating system 510 informs the layer software that the disc is loaded to the drive and the type of the disc. It should be noted that the system further informs the type of the layer selected by the drive when the loaded disc is of a twin format type.

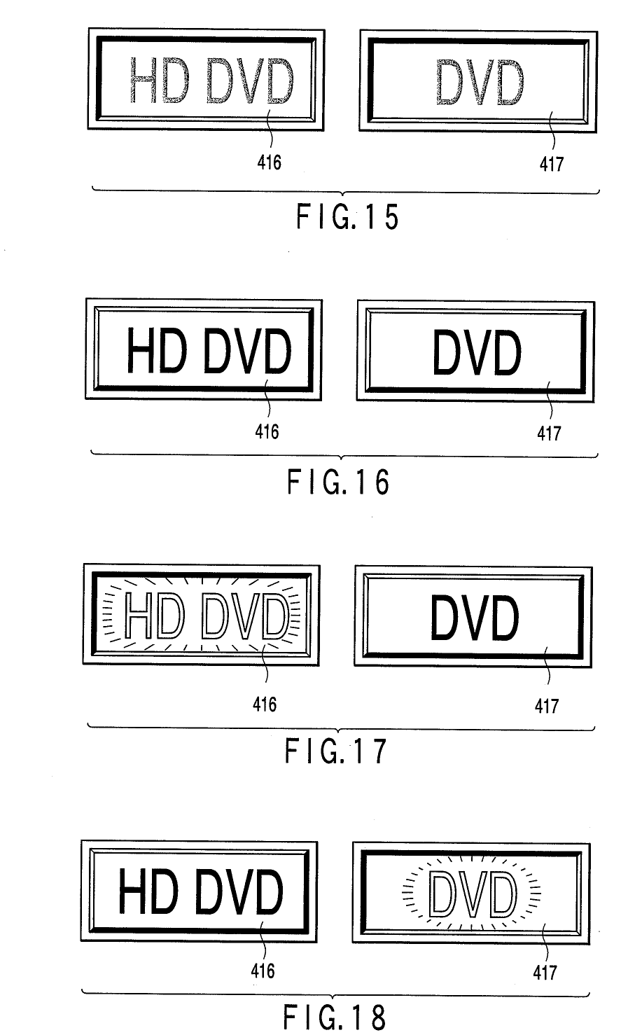

After the drive informs the type of the disc to the operating system 510, the player acquires the data on the type of the disc loaded on the drive from the operating system 510. The disc type identification section 505 judges whether or not the type of the disc acquired is a DVD (step S14). When the disc is identified as DVD, the disc type identification section 505 informs the playback switch section 507 that a DVD is inserted to the ODD 112. Then, the playback switching section 507 instructs the DVD playback section 502 to reproduce the contents recorded on the DVD (step S28). During this period, the HD DVD layer selection button 416 and the DVD layer selection button 417 are not displayed. However, it is alternatively possible to create a status visually indicating that the HD DVD layer selection button 416 and the DVD layer selection button 417 cannot be selected as shown in FIG. 15.

In the case where it is judged that the disc is not a DVD (No in step S14), the disc type identification section 505 judges whether or not the type of the disc is of a twin format type (step S15). In the case where it is judged that the disc is not of a twin format type, (No in step S15) the disc type identification section 505 informs the playback switch section 507 that an HD DVD is inserted to the ODD 112. Then, the playback switching section 507 instructs the HD DVD playback section 501 to reproduce the contents recorded on the HD DVD (step S21).

In the case where it is judged that the disc is of a twin format type (Yes in step S15), the disc type identification section 505 instructs the selection button display section 504 to display a selection dialog. The selection button display section 504 displays the HD DVD layer selection button 416 and the DVD layer selection button 417 on the LCD (step S16) as shown in FIG. 16. Here, the HD DVD layer selection button 416 and the DVD layer selection button 417 are visually indicated so that they can be operated.

When the user operations one of the HD DVD layer selection button and the DVD layer selection button, the OS informs the type of the operated button to the startup program (IA1).

The operation button identification section 506 judges whether or not the operated button is the HD DVD layer selection button 416 (step S17). In the case where it is judged that the HD DVD layer selection button 416 was operated (Yes in step S17), the operation button identification section 506 informs the selected button display section 504 and the playback switching section 507 that the HD DVD layer was selected (step S18). The selected button display section 504 displays such a state that the HD DVD layer selection button 416 was pushed and the letters of HD DVD are lit (step S19) as shown in FIG. 17.

In the initial stage, the drive accesses the HD DVD layer. The playback switching section 507 instructs the drive to reproduce the data stored on the disc and the HD DVD layer selection button is not playback section 501 to reproduce the contents (step S21). In the case where it is judged that the HD DVD layer selection button 416 was not operated (that is, the DVD layer selection button 417 was operated) (No in step S17), the operation button identification section 506 informs the selected button display section 504 and the playback switching section 507 that the DVD layer was selected (step S22). The selected button display section 504 displays such a state that the DVD layer selection button 417 was pushed and the letters of DVD are lit (step S23) as shown in FIG. 18.

In the initial stage, the drive accesses the HD DVD layer. The playback switching section 507 instructs the ODD 112 to change the layer to be accessed from the HD DVD layer to the DVD layer (step S24). The ODD 112 execute the process of changing the layer to be accessed from the HD DVD layer to the DVD layer. When the switching process is finished, the ODD 112 informs the OS that the disc accesses the DVD layer of the twin disc.

When the player software 500 recognizes that a DVD is loaded, the playback switching section 507 instructs the DVD playback section 502 to reproduce the contents of the disc (step S26).

With the process described above, it is possible for the use to select which one of the layers is to be accessed when a twin format disc is loaded in the drive.

With the process described above, it is possible for the use to select a layer to be accessed when a twin format disc is loaded in the ODD 112. Further, the button operated by the user is displayed such that it was pushed and the letters are lit, it is possible to identify the layer selected by the user and the layer accessed by the ODD 112.

It should be noted that when a twin format disc is inserted, the user can operate one of the HD DVD layer selection button 416 and the DVD layer selection button 417 to switch the layer to be reproduced.

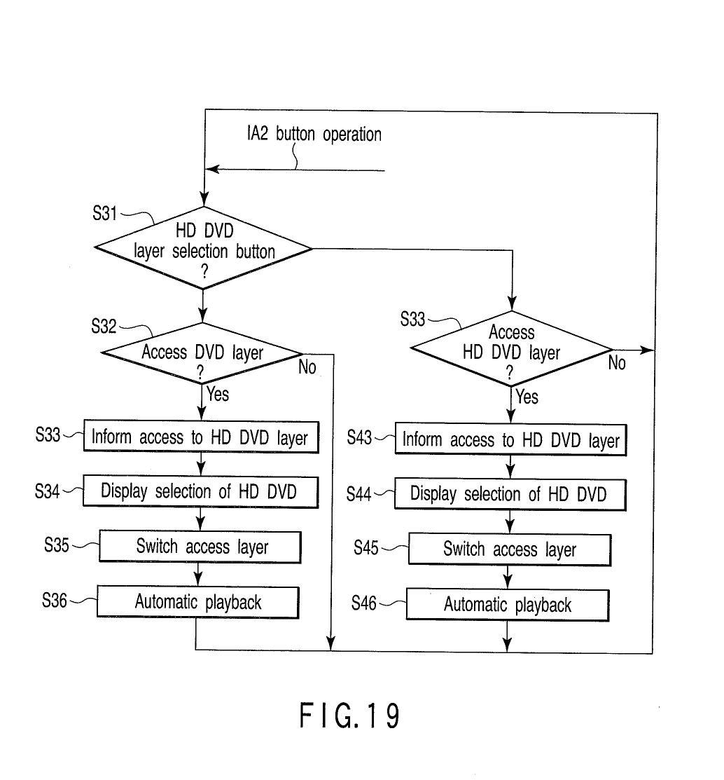

The procedure of the process for switching the playback in a twin format disc will now be described with reference to FIG. 19. The operation of the HD DVD layer selection button 416 or the DVD layer selection button 417 means that the user operates the touch pad control button 16 while the cursor is placed on the button 416 or 417. It should be noted that it is displayed visually that the button is depressed and cannot be operated, the operating system 510 informs the player software 500 that the button was operated.

When the user operates one of the HD DVD layer selection button 416 and the DVD layer selection button 417, the operating system 510 informs the player software 500 in an interrupt that the button was operated (IA2).

The operation button identification section 506 judges whether or not the operated button is the HD DVD layer selection button 416 (step S31). In the case where it is judged that the operated button is the HD DVD layer selection button 416 (Yes in step S31), the operation button identification section 506 identifies whether the accessed layer is the DVD layer (step S32). In the case where it is judged that the DVD layer is not accessed (No in step S32), the operation button identification section 506 does not carry out any process. In the case where it is judged that the DVD layer is accessed (Yes in step S32), the operation button identification section 506 informs the selected button display section 504 and the playback switching section 507 that the HD DVD layer was selected (step 33). The selected button display section 504 displays such a state that the HD DVD layer selection button 416 was pushed and the letters of HD DVD are lit (step S34) as shown in FIG. 17.

When the DVD layer is currently accessed, the playback switching section 507 instructs the ODD 112 to change the layer to be accessed from the DVD layer to the HD DVD layer (step S35). The ODD 112 execute the process of changing the layer to be accessed from the DVD layer to the HD DVD layer. When the switching process is finished, the ODD 112 informs the operating system 510 that the disc accesses the HD DVD layer of the twin disc.

When the player software 500 recognizes that the ODD 112 accessed the HD DVD layer, the playback switching section 507 instructs the HD DVD playback section 501 to reproduce the contents of the disc (step S36).

In the case where it is judged in step S41 that the operated button is not the HD DVD layer selection button 416 (No in step S41), the operation button identification section 506 identifies whether or not the accessed layer is the HD DVD layer (step S42).

In the case where it is judged that the HD DVD layer is not accessed (No in step S42), the operation button identification section 506 does not carry out any process. In the case where it is judged that the HD DVD layer is accessed (Yes in step S24), the operation button identification section 506 informs the selected button display section 504 and the playback switching section 507 that the DVD layer was selected (step 43). The selected button display section 504 displays such a state that the DVD layer selection button 417 was pushed and the letters of DVD are lit (step S44) as shown in FIG. 18.

When the HD DVD layer is currently accessed, the playback switching section 507 instructs the ODD 112 to change the layer to be accessed from the HD DVD layer to the DVD layer (step S45). The ODD 112 execute the process of changing the layer to be accessed from the HD DVD layer to the DVD layer. When the switching process is finished, the ODD 112 informs the operating system 510 that the disc accesses the DVD layer of the twin disc.

When the player software 500 recognizes that the ODD 112 accessed the DVD layer, the playback switching section 507 instructs the DVD playback section 502 to reproduce the contents of the disc (step S46).

With the process described above, it is possible to change the layers is to be accessed even after a twin format disc is loaded in the ODD 112 and the layer to be accessed has been selected. Further, the button operated by the user is displayed such that it was pushed and the letters are lit, it is possible for the user to identify the layer selected by the user and the layer accessed by the ODD 112.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
an optical disc apparatus configured to read data recorded on a type of optical disc selected from the group comprising a first optical disc including a recording layer recorded in a first physical format accessed by first laser light, a second optical disc including a recording layer recorded in a second physical format accessed by second laser light, and a third optical disc including a first recording layer recorded in the first physical format and a second recording layer recorded in the second physical format;
an identification unit configured to identify the type of optical disc when it is loaded in the optical disc apparatus;
a display unit configured to display an interface allowing a user to select a recording to be accessed by the optical disc apparatus when it is judged that the third optical disc type is loaded;
an access layer instructing unit configured to instruct the optical disc apparatus to access a selected recording layer if the user makes a selection; and
an operation result display unit configured to display information about the selected recording layer.

2. The information processing apparatus according to claim 1, wherein the display unit is configured to display a first button and a second button when the third optical disc type is loaded in the optical disc apparatus and the access layer instructing unit is configured to instruct the optical disc apparatus to access the first recording layer of the optical disc when the user activates the first button and to access the second recording layer of the optical disc when the user activates the second button.

3. The information processing apparatus according to claim 2, wherein the operation result display unit is configured to display on the first button information about the selected recording layer when the first button is operated, and to display on the second button information about the selected recording layer when the second button is operated.

4. The information processing apparatus according to claim 1, further comprising:
a first playback unit configured to play video and audio contents recorded in the first physical format; and
a second playback unit configured to play video and audio contents recorded in the second physical format.

5. A method of controlling an information processing apparatus, the method comprising:
identifying whether a type of optical disc is loaded in an optical disc apparatus, the type of optical disc being selected from the group comprising a first optical disc including a recording layer recorded in a first physical format accessed by first laser light, a second optical disc including a recording layer recorded in a second physical format accessed by second laser light, and a third optical disc including a first recording layer recorded in the first physical format and a second recording layer recorded in the second physical format;
displaying on a display device an interface allowing a user to select a recording to be accessed by the optical disc apparatus when it is judged that the third optical disc type is loaded;
instructing the optical disc apparatus to access a selected recording layer in response to user input; and
displaying information about the selected recording layer.

6. The method according to claim 5, further comprising:
displaying on a display device a first button and second button in when the third optical disc type is loaded in the optical disc apparatus; and
instructing the optical disc apparatus to access the first recording layer of the optical disc when the user activates the first button, and instructing the optical disc apparatus to access the second recording layer of the optical disc when the user activates the second button.

7. The method according to claim 6, further comprising:
displaying on the first button data about the selected recording layer when the first button is operated; and
displaying on the second button data about the selected recording layer when the second button is operated.
